(19) United States
(12) Patent Application Publication
(10) Pub. No.: US 2026/0367801 A1
(43) Pub. Date: Nov. 19, 2026

(54) RECLAIMING AND REPURPOSING END OF LIFE STORAGE DEVICES

(71) Applicant: Sandisk Technologies, Inc., Milpitas, CA (US)

(72) Inventors: GRISHMA SHAH, Milpitas, CA (US); JUDAH GAMLIEL HAHN, Ofra (IL); STEPHEN GOLD, Fort Collins, CO (US)

(73) Assignee: Sandisk Technologies, Inc., Milpitas, CA (US)

(21) Appl. No.: 19/207,437

(22) Filed: May 14, 2025

(51) Int. Cl. G06F 3/06

(52) U.S. Cl. CPC G06F 3/0616; G06F 3/0629; G06F 3/0679

(57) ABSTRACT

A storage device may reconfigure a multi-level cell memory device to a single-level cell memory device to extend the life of the storage device. The storage device includes a multi-level cell memory device to store host and user data. A controller on the storage device may execute host workload that uses up program-erase cycles on the multi-level cell memory device. The controller may determine when the multi-level cell memory device has used the program-erase cycles for the format in which the multi-level cell memory device is configured. The controller may also enable conversion of multi-level cell blocks on the multi-level cell memory device to single-level cell blocks and reconfigure the multi-level cell memory device to a single-level cell memory device.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in the blocks on the memory device. Data may be stored in the blocks in various formats, with the formats being defined by the number of bits that may be stored per memory cell. For example, a single-level cell (SLC) format may write one bit per memory cell, a multi-level cell (MLC) format may write two bits per memory cell, a triple-level cell (TLC) format may write three bits per memory cell, a quadruple-level cell (QLC) format may write four bits per memory cell, and so on. A format used to store fewer bits per memory cell may be accessed faster and may be more expensive than a format used to store more bits per memory cell.

A memory device may be configured as a SLC, MLC, TLC, and/or QLC device, wherein the life span of the memory device, as provided in an end-of-life specification, may be determined by the number program/erase (PE) cycles associated with format in which the memory cells are configured. For example, a client storage device including an SLC memory device has the highest endurance with 100,000 PE cycles, followed by a storage device including an MLC memory device with 10,000 PE cycles, a TLC memory device with 3,000 PE cycles, and a QLC memory device with 1,000 PE cycles. An enterprise storage device used, for example, in data centers including an SLC memory device has an endurance of 200,000 PE cycles, an endurance of 20,000 PE cycles for a MLC memory device, an endurance of 5,000 PE cycles for a TLC memory device, and an endurance of 2,000 PE cycles for a QLC memory device. Once a memory device uses ups the PE cycles as provided in the end-of-life specification, the storage device may reach an end-of-life phase and may become unstable, possibly resulting in erase, program, and/or read errors. At some point after the storage device reaches its end-of-life phase, the storage device may enter a read-only state.

In some storage devices, the memory device may be configured to support multiple formats, and the life span of the storage device may be determined by the number PE cycles associated with the memory format storing more bits per cell. For example, a portion of a memory device may be configured in the SLC format, and a portion of the memory device may be configured in the QLC format, wherein the storage device may determine if it wants to store data in the SLC portion or the QLC portion of the memory device. The life span of the storage device may be capped according to the PE cycles associated with the QLC format.

A storage device including a multi-level cell memory device, i.e., a memory device configured to store more than one bits per memory cell, may be configured as a storage class device with lower performance and more storage capacity. A storage device including SLC memory may be configured as a compute-class device for higher performance, and considering the endurance of SLC memory, the compute-class device may perform more write operations than a storage class device. As the need for data storage increases, for example, with the explosion of data being generated and stored at data centers, multi-level cell storage devices with limited endurance (i.e., fewer PE cycles) may reach the end-of-life phase faster and may have to be replaced.

Storage device vendors may be requested to prevent storage devices from entering a read-only state after the PE cycles is used up even though the storage device may experience erase, program, and/or read errors above an acceptable limit as determined by the quoted end-of-life specification. The vendors may be requested to, for example, double the number of PE cycles the storage device may use before it enters a read-only state, with the understanding that the storage device may have defects after the quoted end-of-life limit and may not meet certain performance specifications after the quoted end-of-life limit. With this approach, the life span of the storage device may increase to two times above the quoted end-of-life limit, with the risk of data loss after the quoted end-of-life limit.

### SUMMARY OF THE INVENTION

In some implementations, a storage device may reconfigure a multi-level cell memory device to a single-level cell memory device to extend the life of the storage device. The storage device includes a multi-level cell memory device to store host and user data. A controller on the storage device may execute host workload that uses up program-erase cycles on the multi-level cell memory device. The controller may determine when the multi-level cell memory device has used the program-erase cycles for the format in which the multi-level cell memory device is configured. The controller may also enable conversion of multi-level cell blocks on the multi-level cell memory device to single-level cell blocks and reconfigure the multi-level cell memory device to a single-level cell memory device.

In some implementations, a storage device may reconfigure a multi-level cell memory device to a single-level cell memory device to extend the life of the storage device. The storage device includes a multi-level cell memory device to store host and user data. The multi-level cell memory device includes a multi-level cell endurance group and a single-level cell endurance group. A controller on the storage device may enable thin provisioning of the multi-level cell endurance group and the single-level cell endurance group and execute host workload that uses up program-erase cycles on the multi-level cell memory device. The controller may also determine when the multi-level cell memory device has used the program-erase cycles for the format in which the multi-level cell memory device is configured. The controller may enable the conversion of multi-level cell blocks on the multi-level cell memory device to single-level cell blocks and reconfigure the multi-level cell memory device to a single-level cell memory device with a program-erase cycle up to a single-level cell endurance limit.

In some implementations, a method is provided on the storage device for reconfiguring a multi-level cell memory device to a single-level cell memory device to extend the life of the storage device. The method includes executing host workload that uses up program-erase cycles on the multi-level cell memory device. The method also includes determining when the multi-level cell memory device has used the program-erase cycles for the format in which the multi-level cell memory device is configured. The method further includes enabling conversion of multi-level cell blocks on the multi-level cell memory device to single-level cell blocks and reconfiguring the multi-level cell memory device to a single-level cell memory device with a program-erase cycle up a single-level cell endurance limit.

### BRIEF DESCRIPTION OF THE DRAWINGS

FIG. 1 is a schematic block diagram of an example system in accordance with some implementations.

FIG. 2 is an example flow diagram for reclaiming a multi-level cell storage device at the end-of-life phase in accordance with some implementations.

FIG. 3 is another example flow diagram for reclaiming a multi-level cell storage device at the end-of-life phase in accordance with some implementations.

FIG. 4 is another example flow diagram for reclaiming a multi-level cell storage device at the end-of-life phase in accordance with some implementations.

FIG. 5 is a diagram of an example environment in which systems and/or methods described herein are implemented.

FIG. 6 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

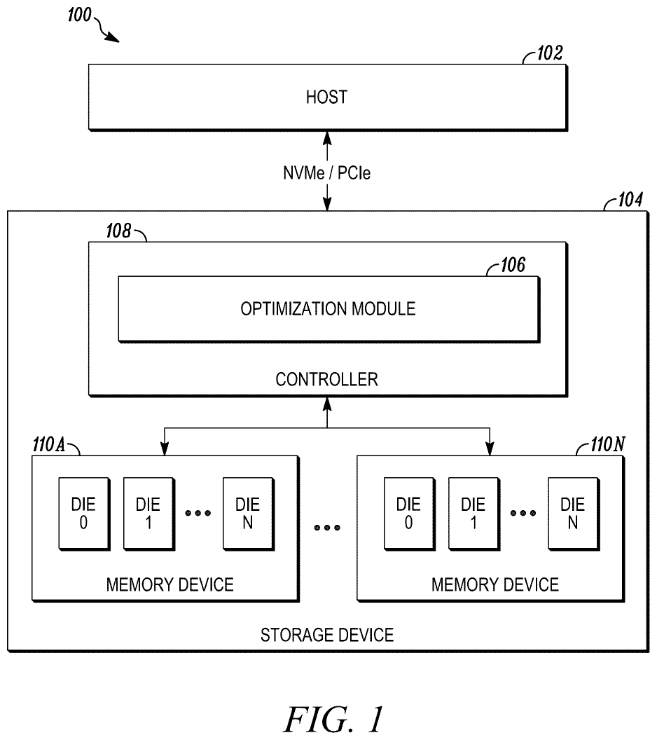

FIG. 1 is a schematic block diagram of an example system in accordance with some implementations. System 100 may include a host 102 and a storage device 104 that may be in the same physical location as components on a single computing device or on different computing devices that are communicatively coupled. Host 102 may provide operational power for storage device 104 and notify storage device 104 about the maximum/peak host power to be used by storage device 104. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include an optimization module 106, a controller 108 and one or more storage components such as non-volatile memory devices 110a-110n (referred to herein as the memory device(s) 110). Optimization module 106 may be used to reconfigure storage device 104 when storage device 104 reaches an end-of-life phase. Controllers 108 may interface with host 102 and process foreground operations including instructions transmitted from host 102. For example, controllers 108 may read data from and/or write to memory devices 110 based on instructions received from host 102. Controllers 108 may also execute background operations to manage resources on memory device 110. For example, controllers 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies (for example, die 0-N) connected to a memory bus including data lines and chip enable lines. Data may be stored in the blocks in various formats, with the formats being defined by the number of bits that may be stored per memory cell. For example, a single-level cell (SLC) format may store one bit per memory cell, a multi-level cell (MLC) format may store two bits per memory cell, a triple-level cell (TLC) format may store three bits per memory cell, a quadruple-level cell (QLC) format may store four bits per memory cell, and so on. A format used to store fewer bits per memory cell may be accessed faster than a format used to store more bits per memory cell.

When the blocks on memory device 110 are configured according to the SLC format, memory device 110 may be referred to herein as a SLC memory device 110 and the connected storage device 104 may be referred to herein as a SLC storage device 104; when the blocks on memory device 110 are configured according to the MLC format, memory device 110 may be referred to herein as a MLC memory device 110 and the connected storage device 104 may be referred to herein as a MLC storage device 104; when the blocks on memory device 110 are configured according to the TLC format, memory device 110 may be referred to herein as a TLC memory device 110 and the connected storage device 104 may be referred to herein as a TLC storage device 104; and when the blocks on memory device 110 are configured according to the QLC format, memory device 110 may be referred to herein as a QLC memory device 110 and the connected storage device 104 may be referred to herein as a QLC storage device 104.

Depending on the class of storage device 104 (for example, client or enterprise), a SLC storage device 104 may have the highest endurance with 100,000-200,000 program-erase (PE) cycles, an MLC storage device 104 may have an endurance of 10,000-20,000 PE cycles, a TLC storage device 104 may have an endurance of 3,000-5,000 PE cycles, and a QLC storage device 104 may have an endurance of 1,000-2,000 PE cycles. When the blocks on memory device 110 are configured to write more than one bit per memory cell, memory device 110 may be referred to herein as a multi-level cell memory device 110 and the connected storage device 104 may be referred to herein as a multi-level cell storage device 104.

Due to the ability of multi-level cell storage devices 104 to store more data and the limited number of PE cycle associated with multi-level cell storage device 104, multi-level cell storage device 104 may be used as storage class devices with lower performance requirements. A multi-level cell storage device 104 configured in a format that writes more bits per memory cell may store more data and be less durable than a storage device that includes the same capacity memory device 110 and is configured in a format that stores fewer bits per memory cell. For example, a QLC storage device 104 may store more data than a TLC, MLC, or SLC storage device 104 having the same size memory device 110. Considering that a SLC memory device 110 stores fewer bits per memory cell than a multi-level cell memory device 110 and SLC blocks have higher voltage threshold margins and faster performance than multi-level cell blocks, a SLC storage device 104 may store less data than multi-level cell storage devices 104 that have the same memory capacity and the SLC storage device 104 may be used as a compute-storage device.

In an implementation, optimization module 106 may be used to reconfigure a multi-level cell memory device 110 to last longer than the life-time provided in a quoted end-of-life specification. A multi-level cell memory device 110 may be designed to be repurposed as a SLC memory device 110 and to last until a repurposed SLC memory device 110 reaches its end-of-life. Therefore, when storage device 104 cycles a multi-level cell memory device 110 to an end-of-life phase, the blocks in multi-level cell memory device 110 may still be reliably used as SLC blocks as storage device 104 has not used all PE cycles associated with the SLC format. For example, when storage device 104 cycles a QLC memory device 110 to an end-of-life phase, the blocks on QLC memory device 110 may have used 1,000-2,000 PE cycles. The blocks on QLC memory device 110 may still be reliably used as SLC blocks as storage device 104 has not used the 100,000-200,000 PE cycles associated with the SLC format. As such, when the multi-level cell storage device 104 uses up its PE cycles, controller 108 may execute optimization module 106 to enable conversion of multi-level cell blocks on a multi-level cell memory device 110 to SLC blocks such that the SLC blocks may be used up to the SLC endurance limit, thus converting multi-level cell memory device 110 to SLC memory device 110.

When, for example, a QLC memory device 110 reaches its end-of-life phase and is converted from QLC memory device 110 to SLC memory device 110, the capacity of SLC memory device 110 may be a fourth of the capacity of QLC memory device 110. In an example where TLC memory device 110 reaches its end-of-life phase and is converted from TLC memory device 110 to SLC memory device 110, the capacity of SLC memory device 110 may be a third of the capacity of TLC memory device 110. In the example where MLC memory device 110 reaches its end-of-life phase and is converted from MLC memory device 110 to SLC memory device 110, the capacity of SLC memory device 110 may be a half of the capacity of the MLC memory device 110.

Consider an example where a QLC memory device 110 in a client storage device 104 reaches the end-of-life phase, wherein QLC memory device 110 has used up 1000 PE cycles. Controller 108 may execute optimization module 106 to enable a conversion from the QLC memory device 110 to a SLC memory device 110. For example, optimization module 106 may convert QLC blocks in QLC memory device 110 to SLC blocks. When QLC memory device 110 is converted to SLC memory device 110, SLC memory device 110 may still have 99,000 PE cycles left before it reaches its end-of-life phase. With the conversion from a multi-level cell memory device 110 to SLC memory device 110, storage device 104 may change from a storage class drive with a higher capacity to a compute-class drive (i.e., a device with SLC memory) with lower capacity and increased performance.

When a multi-level cell storage device 104 is used, for example, in a personal computer, gaming console, or data center, multi-level cell storage device 104 may execute host workloads that may use up the PE cycles on multi-level cell storage device 104. When multi-level cell storage device 104 reaches its end-of-life, as determined by the storage device specification, host 102 and/or controller 108 may copy user and control data on multi-level cell memory device 110 to a different location. For example, the data on multi-level cell memory device 110 may be copied to an external memory device (not shown in FIG. 1). Host 102 and/or controller 108 may perform a secure erase operation on multi-level cell memory device 110 and optimization module 106 may reconfigure multi-level cell storage device 104 to a single level cell storage device 104.

In one example, when multi-level cell storage device 104 is nearing an end-of-life phase, host 102 and/or controller 108 may determine if multi-level cell storage device 104 includes an option to convert multi-level cell storage device 104 to a single level cell storage device 104. If host 102 and/or controller 108 determines that such an option exists on multi-level cell storage device 104, host 102 and/or controller 108 may download and/or activate firmware associated with optimization module 106 on multi-level cell storage device 104 to enable optimization module 106 to convert multi-level cell memory device 110 to a single level cell memory device 110. In some cases, the firmware associated with optimization module 106 may be locked via, for example, a cryptographic mechanism, and may be unlocked after a key is provided to multi-level cell storage device 104. Host 102 and/or controller 107 may copy data on multi-level cell memory device 110 to an external memory device (not shown in FIG. 1). Host 102 and/or controller 108 may then perform a secure erase operation on multi-level cell memory device 110 and optimization module 106 may reconfigure multi-level cell storage device 104 to a single level cell storage device 104. After optimization module 106 converts the multi-level cell memory device 110 to a SLC memory device 110, host 102 and/or controller 108 may copy the data from the external memory device to the SLC memory device 110.

In another example, when multi-level cell storage device 104 is nearing an end-of-life phase, controller 108 may determine if multi-level cell storage device 104 includes an option to convert multi-level cell storage device 104 to a single level cell storage device 104. If controller 108 determines that such a feature exists on storage device 104, controller 108 may send an indication to host 102 to enable host 102 (or a user of host 102 via, for example, a display on host 102) to select an option to convert multi-level cell storage device 104 to a single level cell storage device 104. If host 102 selects and sends an indication/response to multi-level cell storage device 104 for controller 108 to convert multi-level cell memory device 110 to a single level cell memory device 110, controller 108 may activate and/or download firmware associated with optimization module 106 on storage device 104 to repurpose multi-level cell storage device 104 to a single level cell storage device 104.

In another example, when multi-level cell storage device 104 reaches the end-of-life phase, storage device 104 may be returned to a vendor to repurpose a multi-level cell memory device 110 to a single level cell memory device 110. When storage device 104 is reconfigured from multi-level cell storage device 104 to a single level cell storage device 104, storage device 104 may be used as a new product, i.e., as a single-level-cell storage device 104 with a new end-of-life that is associated with the single-level cell format.

Storage device 104 may be configured for thin provisioning, wherein storage device 104 may create a virtual storage pool that may appear larger than the physical storage capacity on memory device 110. In an implementation, multi-level cell storage device 104 may have thin provisioning enabled for a multi-level cell endurance group and a single-level cell endurance group. The SLC endurance group may start with no namespace and no capacity assigned to it, and all the capacity may be assigned to a multi-level cell endurance group. Optimization module 106 with SLC optimization firmware may be activated prior to the conversion of multi-level cell memory device 110 to a single level cell memory device 110.

When multi-level cell memory device 110 reaches the end-of-life phase, host 102 may issue a critical end-of-life warning. At the end-of life of multi-level cell memory device 110, controller 108 and/or another processor (including, for example, optimization module 106 or another migration tool) may populate the SLC endurance group with new namespace(s). Host 102 and/or controller 108 may migrate content from the multi-level cell endurance group and to the SLC endurance group via, for example live migration or device-to-device copy. Using this approach, history (for example, metadata including errors, event logs, bad block history, etc.) may be maintained on storage device 104. Controller 108 and/or host 102 may delete the multi-level cell endurance group when the migration is complete and fully provision storage device 104 as a SLC storage device 104.

In an example where multi-level cell storage device 104 is used in a gaming console or an artificial intelligence device, at the end-of-life phase on multi-level cell storage device 104, a user on host 102 may be given a choice of a faster storage device with less capacity. If the user chooses an option to convert the multi-level cell storage device 104 to SLC storage device 104, the user may initiate the conversion to SLC storage device 104 and host 102 may provide an indication/response to multi-level cell storage device 104. When multi-level cell storage device 104 receives the indication, at the end-of-life of storage device 104, controller 108 on multi-level cell storage device 104 may initiate conversion to a single level cell storage device 104.

Controller 108 and/or optimization module 106 may free up capacity on multi-level cell storage device 104 to allow for conversion to SLC storage device 104.

Consider an example where a TLC memory device 110 used in a gaming console reaches the end-of-life stage. To convert TLC memory device 110 to a SLC memory device 110, controller 108 and/or optimization module 106 may create thinly provisioned SLC namespace(s). Controller 108 and/or optimization module 106 may estimate how much space is needed to migrate content from TLC namespace(s) to SLC namespace(s). Controller 108 and/or optimization module 106 may create a partition with a SLC namespace, move content over from the TLC namespace to the SLC namespace, delete the TLC namespace and reclaim the TLC space and perform this process in an iterative loop, until all of the content in the TLC namespace(s) have been migrated to the SLC namespace(s). Controller 108 and/or optimization module 106 may delete the second-tier partition with the TLC namespace(s) and reboot and initialize as storage device 104 as SLC storage device 104.

Storage device 104 may perform these processes based on one or more processors, for example, controller 108 and/or optimization module 106 executing software instructions stored by a non-transitory computer-readable medium, such as a storage component including, for example, memory device 110. As used herein, the term “computer-readable medium” refers to a non-transitory memory device.

Software instructions may be read into the storage component from another computer-readable medium or from another device. When executed, software instructions stored in the storage component may cause controller 108 and/or optimization module 106 to perform one or more processes described herein. Additionally, or alternatively, hardware circuitry may be used in place of or in combination with software instructions to perform one or more processes described herein. For example, the processes described herein may be executed by various components of drive controller 108 and/or optimization module 106, such as processors, logic gates, switches, application specific integrated circuits (ASICs), programmable logic controllers, embedded microcontrollers, and other components of controller 108 and/or optimization module 106. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

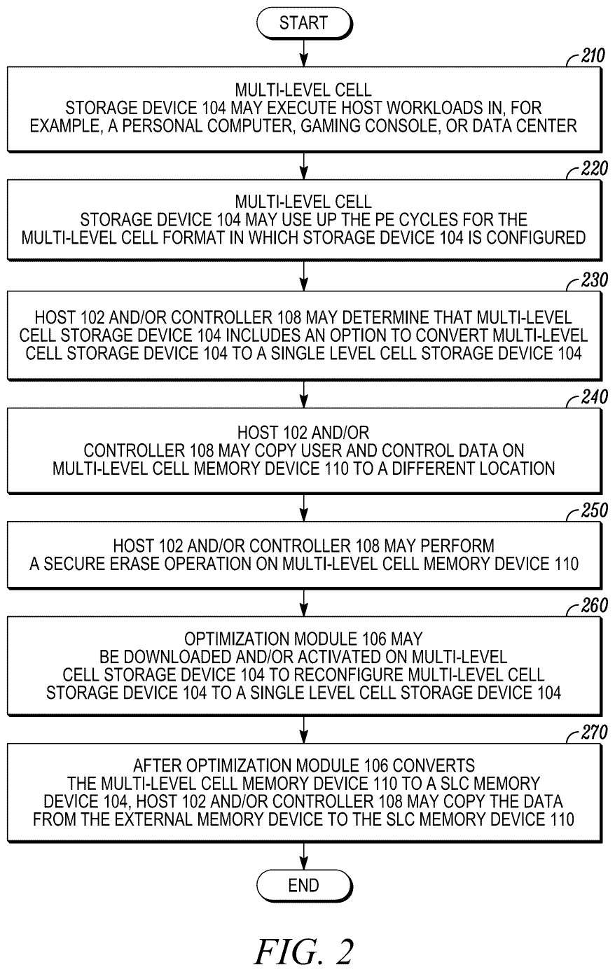

FIG. 2 is an example flow diagram for reclaiming a multi-level cell storage device at the end-of-life phase in accordance with some implementations. At 210, multi-level cell storage device 104 may execute host workloads in, for example, a personal computer, gaming console, or data center. At 220, multi-level cell storage device 104 may use up the PE cycles for the multi-level cell format in which storage device 104 is configured. At 230, host 102 and/or controller 108 may determine that multi-level cell storage device 104 includes an option to convert multi-level cell storage device 104 to a single level cell storage device 104. At 240, host 102 and/or controller 108 may copy user and control data on multi-level cell memory device 110 to a different location. At 250, host 102 and/or controller 108 may perform a secure erase operation on multi-level cell memory device 110. At 260, optimization module 106 may be downloaded and/or activated on multi-level cell storage device 104 to reconfigure multi-level cell storage device 104 to a single level cell storage device 104. At 270, after optimization module 106 converts the multi-level cell memory device 110 to a SLC memory device 104, host 102 and/or controller 108 may copy the data from the external memory device to the SLC memory device 110. FIG. 2 is provided as an example. Other examples may differ from what is described in FIG. 2.

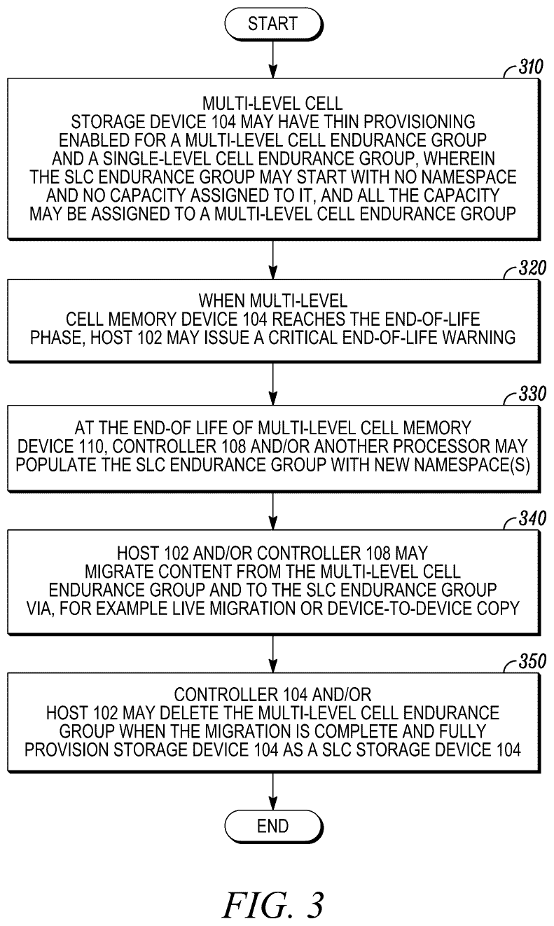

FIG. 3 is another example flow diagram for reclaiming a multi-level cell storage device at the end-of-life phase in accordance with some implementations. At 310, multi-level cell storage device 104 may have thin provisioning enabled for a multi-level cell endurance group and a single-level cell endurance group, wherein the SLC endurance group may start with no namespace and no capacity assigned to it, and all the capacity may be assigned to a multi-level cell endurance group. At 320, when multi-level cell memory device 104 reaches the end-of-life phase, host 102 may issue a critical end-of-life warning. At 330, at the end-of life of multi-level cell memory device 110, controller 108 and/or another processor may populate the SLC endurance group with new namespace(s). At 340, host 102 and/or controller 108 may migrate content from the multi-level cell endurance group and to the SLC endurance group via, for example live migration or device-to-device copy. At 350, controller 104 and/or host 102 may delete the multi-level cell endurance group when the migration is complete and fully provision storage device 104 as a SLC storage device 104. As indicated above FIG. 3 is provided as an example. Other examples may differ from what is described in FIG. 3.

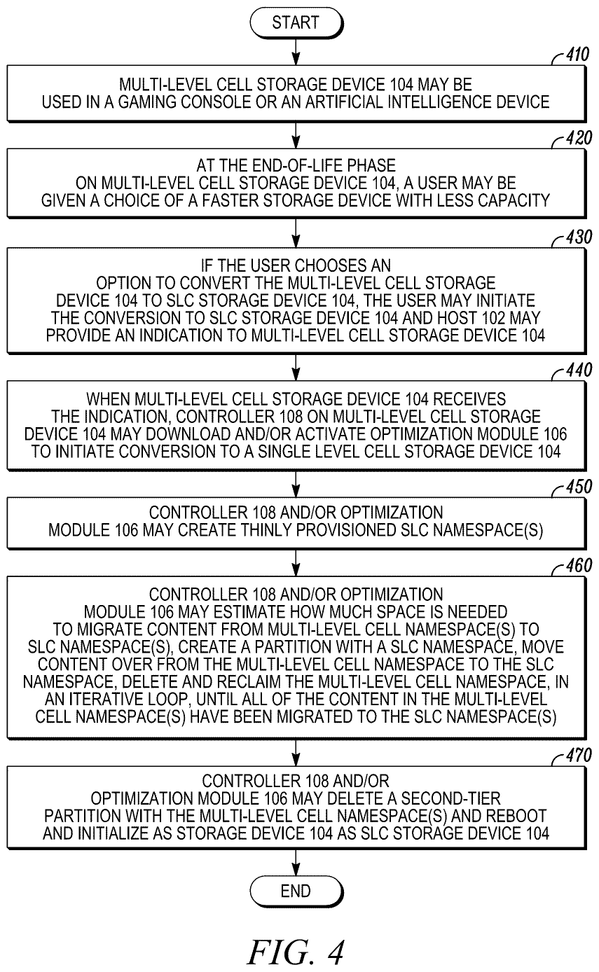

FIG. 4 is another example flow diagram for reclaiming a multi-level cell storage device at the end-of-life phase in accordance with some implementations. At 410, multi-level cell storage device 104 may be used in a gaming console or an artificial intelligence device. At 420, at the end-of-life phase on multi-level cell storage device 104, a user may be given a choice of a faster storage device with less capacity. At 430, if the user chooses an option to convert the multi-level cell storage device 104 to SLC storage device 104, the user may initiate the conversion to SLC storage device 104 and host 102 may provide an indication to multi-level cell storage device 104. At 440, when multi-level cell storage device 104 receives the indication, controller 108 on multi-level cell storage device 104 may download and/or activate optimization module 106 to initiate conversion to a single level cell storage device 104. At 450, controller 108 and/or optimization module 106 may create thinly provisioned SLC namespace(s). At 460, controller 108 and/or optimization module 106 may estimate how much space is needed to migrate content from multi-level cell namespace(s) to SLC namespace(s), create a partition with a SLC namespace, move content over from the multi-level cell namespace to the SLC namespace, delete and reclaim the multi-level cell namespace, in an iterative loop, until all of the content in the multi-level cell namespace(s) have been migrated to the SLC namespace(s). At 470, controller 108 and/or optimization module 106 may delete a second-tier partition with the multi-level cell namespace(s) and reboot and initialize as storage device 104 as SLC storage device 104. It should be noted that if the SLC namespace is in a different endurance group, the wear out levels reported in the endurance group counters may be updated due to the previous usage of the media. As indicated above FIG. 4 is provided as an example. Other examples may differ from what is described in FIG. 4.

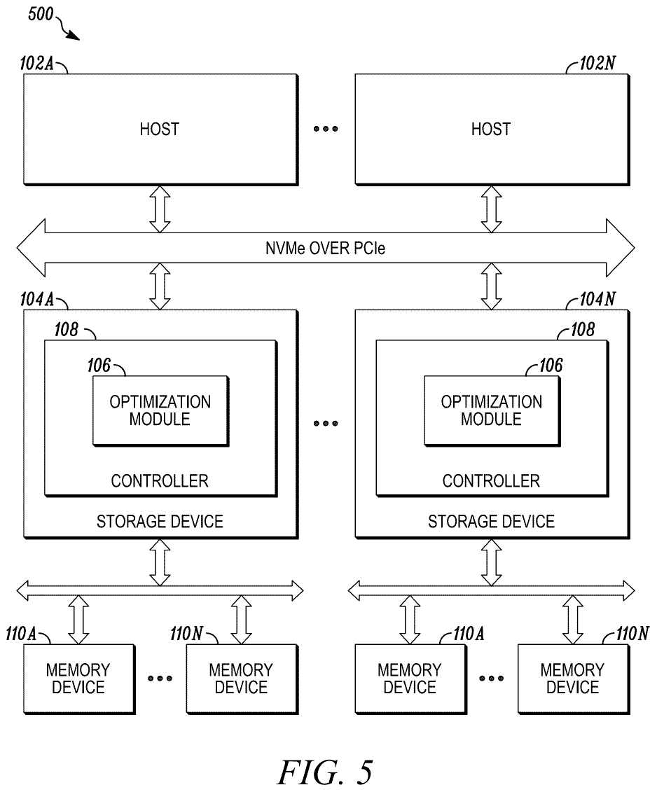

FIG. 5 is a diagram of an example environment in which systems and/or methods described herein are implemented. As shown in FIG. 5, Environment 500 may include hosts 102-102n (referred to herein as host(s) 102), and one or more storage devices 104a-104n (referred to herein as storage device(s) 104). Controller 108 may reconfigure a multi-level cell storage device 104 to a SLC storage device when multi-level cell storage device 104 reaches an end-of-life phase. Hosts 102 and storage devices 104 may communicate via Non-Volatile Memory Express (NVMe) over peripheral component interconnect express (PCI Express or PCIe), SD, or the like.

Devices of Environment 500 may interconnect via wired connections, wireless connections, or a combination of wired and wireless connections. For example, the network in FIG. 5 may include NVMe over Fabric(NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices.

Additionally, or alternatively, a set of devices (e.g., one or more devices) of Environment 500 may perform one or more functions described as being performed by another set of devices of Environment 500.

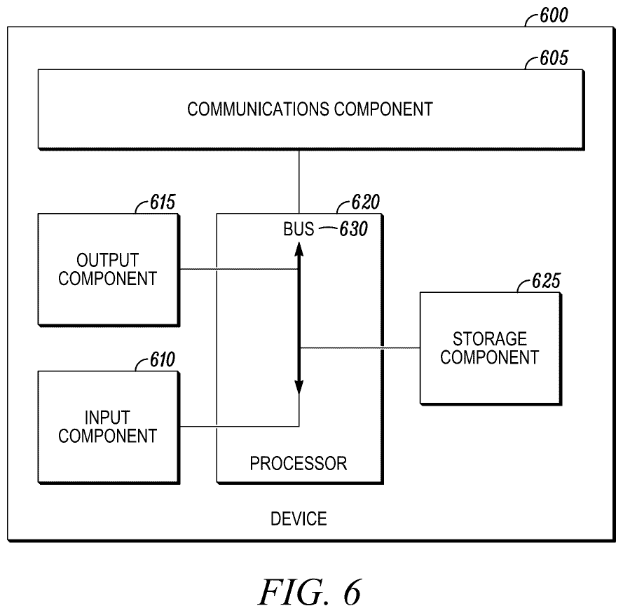

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, and a network/data connection port, or the like), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and network/data connection port, or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range.

Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

1. A storage device to reconfigure a multi-level cell memory device to a single-level cell memory device to extend a life of the storage device, the storage device comprising:
a multi-level cell memory device to store host and user data; and
a controller to determine that the storage device is a multi-level cell storage device with a life span associated with the multi-level cell memory device, execute host workload that uses up program-erase cycles on the multi-level cell memory device, determine when the multi-level cell memory device has used the program-erase cycles for a format in which the multi-level cell memory device is configured and that the multi-level cell storage device is approaching an end-of-life state, perform a secure erasure on the multi-level cell memory device, enable conversion of multi-level cell blocks on the multi-level cell memory device to single-level cell blocks and to reconfigure the multi-level cell storage device to a single-level cell storage device with a program-erase cycle up to a single-level cell endurance limit, wherein the life span of the storage device is changed from the life span associated with the multi-level cell memory device to the life span associated with a single-level cell memory device.

2. The storage device of claim 1, further comprising an optimization module to convert the multi-level cell memory device to the single-level cell memory device.

3. The storage device of claim 1, wherein the multi-level cell memory device is designed to be repurposed to a single-level cell memory device and to last until the single-level cell memory device reaches an end-of-life phase.

4. The storage device of claim 1, wherein a capacity of the single-level cell memory device is less than a capacity of the multi-level cell memory device.

5. The storage device of claim 1, wherein the multi-level cell memory device is reconfigured into a single-level cell memory device, the storage device changes from a storage-class device to a compute-class device.

6. The storage device of claim 1, wherein prior to reconfiguring the multi-level cell memory device to the single-level cell memory device, the controller copies host data and control data from the multi-level cell memory device to another memory device and performs a secure erase of the multi-level cell memory device and after reconfiguring the multi-level cell memory device to the single-level cell memory device, the controller copies the host data and the control data from the other memory device to the single-level cell memory device.

7. The storage device of claim 1, wherein prior to reconfiguring the multi-level cell memory device to the single-level cell memory device, the controller determines that the storage device includes an option to convert the multi-level cell memory device to the single-level cell memory device and activates an optimization module to convert the multi-level cell memory device to the single-level cell memory device.

8. The storage device of claim 1, wherein prior to reconfiguring the multi-level cell memory device to the single-level cell memory device, the controller determines that the storage device includes an option to convert the multi-level cell memory device to the single-level cell memory device, sends an indication to a host and, upon receiving a response from the host, activates an optimization module to convert the multi-level cell memory device to the single-level cell memory device.

9. A storage device to reconfigure a multi-level cell memory device to a single-level cell memory device to extend a life of the storage device, the storage device comprising:
a multi-level cell memory device to store host and user data, the multi-level cell memory device includes a multi-level cell endurance group and a single-level cell endurance group; and
a controller to
determine that the storage device is a multi-level cell storage device with a life span associated with the multi-level cell memory device,
enable thin provisioning of the multi-level cell endurance group and the single-level cell endurance group,
execute host workload that uses up program-erase cycles on the multi-level cell memory device,
determine when the multi-level cell memory device has used the program-erase cycles for a format in which the multi-level cell memory device is configured and that the multi-level cell storage device is approaching an end-of-life state, and
enable conversion of multi-level cell blocks on the multi-level cell memory device to single-level cell blocks to reconfigure the multi-level cell storage device to a single-level cell storage device with a program-erase cycle up to a single-level cell endurance limit,
wherein the life span of the storage device is changed from the life span associated with the multi-level cell memory device to the life span associated with a single-level cell memory device.

10. The storage device of claim 9, wherein the single-level cell endurance group initially starts with no namespace and assigned capacity, and capacity of the multi-level cell memory device is initially assigned to the multi-level cell endurance group.

11. The storage device of claim 10, wherein the controller determines that the multi-level cell memory device is at an end-of-life phase, populates the single-level cell endurance group with at least one namespace and migrates content from the multi-level cell endurance group to the single-level cell endurance group, deletes the multi-level cell endurance group when migration is complete, and fully provisions the storage device as a single-level cell storage device.

12. The storage device of claim 9, wherein the controller determines that the multi-level cell memory device is at an end-of-life phase and provides a user with a choice of a faster storage device with less capacity, wherein the user initiates conversion of a multi-level cell storage device to a single-level cell storage device.

13. The storage device of claim 9, wherein the controller
i) determines that the multi-level cell memory device is at an end-of-life phase,
ii) creates at least one thinly provisioned single-level cell namespace, estimates how much space is needed to migrate content from at least one multi-level cell namespace to the at least one single-level cell namespace, creates a partition with the at least one single-level cell namespace, move content from the at least one multi-level cell namespace to the at least one single-level cell namespace, delete the at least one multi-level cell namespace and reclaim the at least one multi-level cell namespace, and perform this process in an iterative loop until content in at least one multi-level cell namespace have been migrated to the at least one single-level cell namespace.

14. The storage device of claim 13, wherein the controller deletes a partition with the at least one multi-level cell namespace, reboots and initializes the storage device as a single-level cell storage device.

15. A method in a storage device for reconfiguring a multi-level cell memory device to a single-level cell memory device to extend a life of the storage device, the storage device comprising a controller to execute the method comprising:
determining that the storage device is a multi-level cell storage device with a life span associated with the multi-level cell memory device:
executing host workload that uses up program-erase cycles on a multi-level cell memory device;
determining when the multi-level cell memory device has used the program-erase cycles for a format in which the multi-level cell memory device is configured and that the multi-level cell storage device is approaching an end-of-life state; and
enabling conversion of multi-level cell blocks on the multi-level cell memory device to single-level cell blocks and reconfiguring the multi-level cell storage device to a single-level cell storage device with a program-erase cycle up to a single-level cell endurance limit, wherein the life span of the storage device is changed from the life span associated with the multi-level cell memory device to the life span associated with a single-level cell memory device.

16. The method of claim 15, wherein i) prior to reconfiguring the multi-level cell memory device to the single-level cell memory device, the method includes copying host and control data from the multi-level cell memory device to another memory device and performing a secure erase of the multi-level cell memory device and after reconfiguring the multi-level cell memory device to the single-level cell memory device, and ii) after, reconfiguring the multi-level cell memory device to the single-level cell memory device, the method includes copying the host and control data from the other memory device to the single-level cell memory device.

17. The method of claim 15, wherein prior to reconfiguring the multi-level cell memory device to the single-level cell memory device, the method includes determining that the storage device includes an option to convert the multi-level cell memory device to the single-level cell memory device and activating an optimization module to convert the multi-level cell memory device to the single-level cell memory device.

18. The method of claim 15, wherein prior to reconfiguring the multi-level cell memory device to the single-level cell memory device, the method includes determining that the storage device includes an option to convert the multi-level cell memory device to the single-level cell memory device, sending an indication to a host and, upon receiving a response from the host, activating an optimization module to convert the multi-level cell memory device to the single-level cell memory device.

19. The method of claim 15, further comprising:
enabling thin provisioning of a multi-level cell endurance group and a single-level cell endurance group
starting the single-level cell endurance group initially with no namespace and assigned capacity;
initially assigning capacity of the multi-level cell memory device to the multi-level cell endurance group; and
at a multi-level cell memory device end-of-life phase, populating the single-level cell endurance group with at least one namespace and migrating content from the multi-level cell endurance group to the single-level cell endurance group, deleting the multi-level cell endurance group when the migration is complete, and fully provisioning the storage device as a single-level cell storage device.

20. The method of claim 15, further comprising:
determining that the multi-level cell memory device is at an end-of-life phase,
creating at least one thinly provisioned single-level cell namespace, estimating how much space is needed to migrate content from at least one multi-level cell namespace to at least one single-level cell namespace, creating a partition with the at least one single-level cell namespace, moving content from the at least one multi-level cell namespace to the at least one single-level cell namespace, deleting the at least one multi-level cell namespace and reclaiming the at least one multi-level cell namespace, and performing this process in an iterative loop until content in at least one multi-level cell namespace have been migrated to the at least one single-level cell namespace.
